(19) United States
(12) Patent Application Publication
(10) Pub. No.: US 2025/0278510 A1
(43) Pub. Date: Sep. 4, 2025

(54) DISTRIBUTED DATA SECURITY

(71) Applicant: State Farm Mutual Automobile Insurance Company, Bloomington, IL (US)

(72) Inventors: Ian Christopher F. Schmehl, Heath, TX (US); Geoffrey David Skinner, Saybrook, IL (US); Surendranath Gummadi, Cantrall, IL (US)

(21) Appl. No.: 19/067,290

(22) Filed: Feb. 28, 2025

Related U.S. Application Data
(60) Provisional application No. 63/559,306, filed on Feb. 29, 2024.

(51) Int. Cl. G06F 21/62; H04L 9/06

(52) U.S. Cl. CPC G06F 21/6227; H04L 9/0643

(57) ABSTRACT

Described herein are systems and techniques to facilitate the use of third-party and other external interaction data generation systems to generate data that may be used in customer interaction without jeopardizing the security of personal information. Interaction data received from a customer may be stored in a blockchain block and non-personal data may be used to generate a request for interaction data. A hash key based on the personal data may be generated to generate and identify the blockchain and track interaction data for a communications session. Data exchanges may be associated with this hash key so that the system may identify and utilize data in the associated blockchain for operations related to the communications session.

### PRIORITY

This application claims priority to U.S. Provisional Patent Application No. 63/559,306, filed Feb. 29, 2024, which is incorporated herein by reference in its entirety.

### TECHNICAL FIELD

The present disclosure relates to securing user data and other sensitive information when using third-party tools to interact with users and systems providing such information.

### BACKGROUND

Artificial intelligence (AI) and machine learning tools have proliferated recently as advances in processing power have been accompanied by reductions in the cost of the systems that support such technologies. Large language models (LLMs) and other machine-learning models are significant applications of AI (e.g., generative AI) that can be used to facilitate interaction with human users. Increasing numbers of organizations are using models and other AI-based technologies to conduct interactive communications with their customers and/or clients. These models and technologies are often provided to such organizations by third parties in the interest of cost savings and efficiency of implementation.

Because the information used in interactions with an organization's customers or clients may include sensitive and/or personal information, the use of third-party models to facilitate such interactions may expose this sensitive and/or personal information to the third party operating such models. Therefore, it may be a challenge to ensure that the data provided to third-party models facilitating model-assisted interactions remains secure while retaining the benefits of using such models. The examples of the present disclosure are directed to overcoming these challenges and providing a faster and more efficient means of providing effective user interactions while maintaining data security.

### SUMMARY

The systems and methods described herein facilitate the use of third-party and other external interaction data generation systems to generate data that may be used in customer interaction without jeopardizing the security of personal information. Interaction data received from a customer may be stored in a blockchain block and non-personal data may be used to generate a request for interaction data. A hash key based on the personal data may be generated to generate and identify the blockchain and track interaction data for a communications session. Data exchanges may be associated with this hash key so that the system may identify and utilize data in the associated blockchain for operations related to the communications session

For example, the techniques described herein may relate to a computer-implemented method for securely generating interaction data for a communications session, the computer-implemented method comprising receiving, at a distributed data security system, from a user device, user interaction data comprising personal data and non-personal data; executing, at the distributed data security system, a cryptographic function using a subset of the personal data to generate a hash key identifier; querying, by the distributed data security system, using the hash key identifier, an encrypted data structure data store; receiving, at the distributed data security system, from the encrypted data structure data store, query results data; storing, at the distributed data security system, based at least in part on the encrypted data structure query results data, a subset of the user interaction data at a first data unit of an encrypted data structure associated with the hash key identifier; transmitting, from the distributed data security system, to an interaction data generation system, the hash key identifier and a subset of the non-personal data and excluding the personal data; receiving, at the distributed data security system, from the interaction data generation system, responsive interaction data; generating, at the distributed data security system, response data based at least in part on the responsive interaction data and the personal data; storing, at the distributed data security system, a subset of the response data at a second data unit of the encrypted data structure; and transmitting, from the distributed data security system, to the user device, the response data.

In examples, the computer-implemented method may include determining, at the distributed data security system, based at least in part on the responsive interaction data, the hash key identifier; and retrieving, at the distributed data security system, from the encrypted data structure data store, using the hash key identifier, the blockchain. In examples, the computer-implemented method may include generating, at the distributed data security system, based at least in part on receiving the responsive interaction data, the second data unit; and associating, at the distributed data security system, the second data unit with the encrypted data structure. The query results data may include an indicator of the encrypted data structure, and the computer-implemented method may include generating, at the distributed data security system, based at least in part on receiving the user interaction data, the first data unit; and associating, at the distributed data security system, the first data unit with the encrypted data structure. In examples, the query results data may be a null result, and the computer-implemented method may include generating, at the distributed data security system, based at least in part on the null result and the hash key identifier, the encrypted data structure; generating, at the distributed data security system, based at least in part on receiving the user interaction data, the first data unit; and associating, at the distributed data security system, the first data unit with the encrypted data structure. The computer-implemented method may also include receiving, at the distributed data security system, from an operator device, a request for a communications session reconstruction; determining, at the distributed data security system, based at least in part on the request, the hash key identifier; retrieving, by the distributed data security system, using the hash key identifier, the encrypted data structure; generating, by the distributed data security system, using the encrypted data structure, communications session reconstruction data; and transmitting, from the distributed data security system, to the operator device, communications session reconstruction data causing the operator device to generate a visual representation of the communications session. The computer-implemented method may further include determining, by the distributed data security system, from an external data source, using the personal data, additional non-personal data; and transmitting, from the distributed data security system, to the interaction data generation system, with the hash key identifier and the subset of the non-personal data, the additional non-personal data.

In examples, a non-transitory computer-readable medium may include instructions that, when executed by one or more processors configured at a distributed data security system, cause the one or more processors to securely generate interaction data for a communications session by performing operations comprising receiving, from a user device, user interaction data comprising personal data and non-personal data; executing a cryptographic function using a subset of the personal data to generate a hash key identifier; storing a subset of the user interaction data at a first block of a blockchain associated with the hash key identifier; transmitting, to an interaction data generation system, the hash key identifier and a subset of the non-personal data; receiving, from the interaction data generation system, responsive interaction data; generating response data based at least in part on the responsive interaction data and the personal data; storing a subset of the response data at a second block of the blockchain; and transmitting, to the user device, the response data.

In examples, generating the response data may include transmitting the responsive interaction data and the hash key identifier to an operator device; receiving adjusted responsive interaction data and the hash key identifier from the operator device; and generating response data based at least in part on the adjusted responsive interaction data and the personal data. The operations may also include, in response to receiving the adjusted responsive interaction data: determining the blockchain based at least in part on the hash key identifier; generating a third block of the blockchain; and storing the adjusted responsive interaction data at the third block. The operations may include determining, from an external data source, using the personal data, additional non-personal data; and transmitting, to the interaction data generation system, with the hash key identifier and the subset of the non-personal data, the additional non-personal data. The operations may also, or instead, include generating, based at least in part on the hash key identifier, the blockchain; generating, based at least in part on receiving the user interaction data, the first block; and associating the first block with the blockchain. The operations can also include generating, based at least in part on receiving the responsive interaction data, the second block; and associating the second block with the blockchain. In examples, the responsive interaction data comprises one or more of text, images, or video.

In examples, a distributed data security system for securely generating interaction data may include one or more processors; and a non-transitory memory storing computer-executable instructions that, when executed, cause the one or more processors to perform operations comprising receiving, from a user device, user interaction data comprising personal data and non-personal data; executing a cryptographic function using a subset of the personal data to generate a hash key identifier; storing a subset of the user interaction data at a first block of a blockchain associated with the hash key identifier; transmitting, to an interaction data generation system, the hash key identifier and a subset of the non-personal data; receiving, from the interaction data generation system, responsive interaction data; generating response data based at least in part on the responsive interaction data and the personal data; storing a subset of the response data at a second block of the blockchain; and transmitting, to the user device, the response data.

In some examples, the operations may include determining, based at least in part on the responsive interaction data, the hash key identifier; and retrieving, from the blockchain data store, using the hash key identifier, the blockchain. The operations may also include generating, based at least in part on receiving the responsive interaction data, the second block; and associating the second block with the blockchain. The operations may further include transmitting, to the interaction data generation system, with the hash key identifier and the subset of the non-personal data, one or more machine learning model prompts. The operations can also include receiving, from an operator device, a request for a communications session reconstruction; determining, based at least in part on the request, the hash key identifier; retrieving, using the hash key identifier, the blockchain; generating, using the blockchain, communications session reconstruction data; and transmitting, to the operator device, communications session reconstruction data, causing the operator device to generate a visual representation of the communications session.

In examples, a system for securely generating interaction data can include means for receiving, from a user device, user interaction data comprising personal data and non-personal data; means for executing a cryptographic function using a subset of the personal data to generate a hash key identifier; means for storing a subset of the user interaction data at a first block of a blockchain associated with the hash key identifier; means for transmitting, to an interaction data generation system, the hash key identifier and a subset of the non-personal data; means for receiving, from the interaction data generation system, responsive interaction data; means for generating response data based at least in part on the responsive interaction data and the personal data; means for storing a subset of the response data at a second block of the blockchain; and means for transmitting, to the user device, the response data.

This Summary is provided to introduce a selection of concepts in a simplified form that are further described below in the Detailed Description. This Summary is not intended to identify key and/or essential features of the claimed subject matter, nor is it intended to be used as an aid in determining the scope of the claimed subject matter. The term “techniques,” for instance, can refer to system(s), method(s), computer-readable instructions, module(s), component(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar and/or identical items.

FIG. 1 is a block diagram depicting an example distributed data security system according to the examples described herein.

FIG. 2 is a flow diagram illustrating an example process for generating a query and related data structures during a model-facilitated interaction performed using distributed data security systems and techniques according to the examples described herein.

FIG. 3 is a flow diagram illustrating an example process for generating responsive communications and related data structures during a model-facilitated interaction performed using distributed data security systems and techniques according to the examples described herein.

FIG. 4 is a flow diagram illustrating an example process for generating data representing a communications session and related data structures using distributed data security systems and techniques according to the examples described herein.

FIG. 5 is a signal flow diagram illustrating messages and operations that may implemented in distributed data security systems and techniques according to the examples described herein.

FIG. 6 illustrates an example system architecture for a computing device that may be used to implement the systems and architectures described herein.

### DETAILED DESCRIPTION

As technology has advanced and computer networks, computing devices, and other such systems have proliferated, the operations performed using these systems have expanded greatly. This includes operations that process personal information and other types of sensitive data that may be used inappropriately if mishandled. For example, personal data in the hands of unauthorized users may be used to commit fraud and/or access other data that may facilitate improper or illegal acts. Therefore, safeguards have been implemented to protect such sensitive data. For example, legal and regulatory requirements have been put in place that must be followed by entities that process or otherwise handle such sensitive data. Such entities may also have contractual obligations to protect such data. Furthermore, entities handling sensitive information may take steps to protect such information in order to maintain goodwill with their (current and/or prospective) customers and/or users.

AI and machine learning tools have proliferated recently as advances in processing power have been accompanied by reductions in the cost of the systems that support such technologies. Large language models (LLMs) and other machine-learning models are significant applications of AI (e.g., generative AI) that can be used to facilitate interaction with human users. As the sophistication of such models advances, increasing numbers of organizations are using them to conduct interactive communications with users. For example, businesses may use chat applications for communications with customers using an LLM or other forms of generative AI to process the language input received from customers, perform operations to determine appropriate responses, and generate user-friendly output.

The expertise required to implement, train, and operate such models, especially as the sophistication of such models advances, may be substantial and may, therefore, entail significant costs. To avoid the full burden of such costs and to implement their own systems more rapidly and efficiently, many organizations will use models offered by third-party providers rather than attempting to implement, operate, train, and maintain their own models. As will be appreciated, this may potentially entail exposure of these organizations' data to third-party model providers, including sensitive and/or personal data of customers, clients, and/or other users associated with such organizations.

Accordingly, model-assisted interactions implemented using third-party models may include sensitive customer or user information, either provided by the human participant, determined by the model-assisted application, or both. As noted, because machine-learning models may be provided by a third party, there is a risk of exposing sensitive information to such models. For example, organizations using third-party models and systems may have no visibility into the security measures used by the third-party provider within such systems to protect user data. The example systems and methods described herein may be directed toward distributed data security systems and techniques that may improve the security of sensitive information while integrating the use of machine learning and generative AI into communications processes.

Systems and methods for distributed data security disclosed herein may use distributed trust systems and/or distributed ledger systems, such as a blockchain system, to encrypt and track the data exchanged with models, other generative AI systems, and any other type of interaction data generation system, including those that may be provided by a third party. In examples, a data structure of a distributed ledger may be used to track, encrypt, and/or store data associated with a communications session involving a user. Such a ledger may be identified and/or created using a hash key identifier as described herein. In other examples, any other type of encrypted data structure may be used and/or associated with a communications session, and individual data units of such an encrypted data structure may be used to represent or may otherwise be associated with an individual interaction (e.g., a transmission or reception of a communication).

During a communications interaction, such as a chat session with a customer, the exemplary systems may receive or determine personal or sensitive information (referred to generally herein as “personal information”). For instance, a user may include such information in a communication provided to the system, such as a user query. Alternatively or additionally, the system may retrieve or otherwise determine such information, for example, based on information provided by the user.

The disclosed distributed data security system may execute a cryptographic hash function using a subset of the received or determined personal information to generate a hash key as output (e.g., a cryptographic hash, a cryptographic puzzle solution). In examples, this cryptographic hash function may be a mathematical function that generates a string as output when executed using input data. The generated output string may be a unique, fixed-length string that is unique to the provided input when processed using a particular hash function. The generated output string may serve as a hash key in the disclosed systems and techniques.

The system may then generate a blockchain (if necessary) and/or a blockchain block identified by the hash key and store the personal information in the block. Using the hash key as an identifier, the system may then provide other data (e.g., that does not represent personal information) to the third-party model for processing. For example, if the user has a question about the user's automobile, the system may provide data about the automobile (e.g., general make, model, year, features, etc. that may be retrieved from system data sources) to the third-party model without including personal information that may have accompanied, or been determined based on, the user's question (e.g., name, address, account number, driver's license number, etc.). The system may also provide the generated hash key identifier with the generalized automobile data as input to the model.

Note that in some examples, the system may use the hash key generated using a cryptographic hash function as an identifier of a blockchain that may include one or more blocks (also identified by the hash key) representing personal information. Alternatively or additionally, the system may use the hash key generated using a cryptographic hash function as an identifier of a block representing personal information in a blockchain that may use another identifier (e.g., associated a particular interaction). In examples where the system may use the hash key to identify the block with personal information and another identifier for the interaction, the system may provide both identifiers to a model. For a simpler implementation, the system may use the hash key as an identifier for the blockchain (and therefore for each block) and may identify a personal information block based on a block type or other block indicator (e.g., distinct from the hash key generated based on the personal information).

The model may then process the generalized data and maintain the hash key as an identifier for the data and the accompanying processing. The model may generate output and provide the output as responsive data along with the hash key identifier to the system. The system may then identify the personal information block(s) in the blockchain identified using the hash key as an identifier. The system may also identify the particular associated chat interaction based on the blockchain information and/or the hash key identifier. The system may then provide the response to the user via the identifier chat interaction. Alternatively or additionally, the system may provide the model-generated responsive data to an operator of the system for approval, adjustment, supplementation, etc. of such data. This modified data may then be used to provide a response to the user. The operator may also, or instead, determine that the model-generated responsive data is insufficient or inaccurate and request additional data from the model (e.g., including by modifying the original input provided to the model) and/or determine alternative responsive data to provide to the user.

In examples, the distributed data security system may generate a new block in a blockchain associated with a particular communications session (e.g., chat session) for each communications interaction and/or each interaction with a model (e.g. third-party model). The resulting blockchain may securely represent every individual communications exchange in a particular communications session. This communications session blockchain may be used to recreate the interactions in the future, for example, for providing information to a subsequent representative or agent, for auditing or training purposes, etc.

In particular examples, as noted, a distributed data security system may facilitate a communications session with a user and receive a communication from the user that includes personal information. The system may also or instead retrieve personal information and/or other information (e.g., policy information) using user-provided information. The system may execute a blockchain cryptographic function using (at least some of) the received and/or retrieved personal information to generate a hash key as output. The system may generate a blockchain block identified by the hash key and associate the block with a blockchain associated with the communications session. In examples, the system may initiate the blockchain upon initiation of the communications session and/or upon receipt of an initial communication from a user.

The system may store the received and/or retrieved personal information and/or related (e.g., non-personal) information in the block. The system may then generate a query for a model (e.g., for a system that includes a model, such as a third-party LLM execution system) using the hash key as an identifier and including relevant non-personal information needed to support the query. Alternatively or additionally, the system may then generate a query for an interaction data generation system of any type that may be configured to generate and provide interaction data that may be used to support communications with a user. Any such query may include a hash key as an identifier and relevant non-personal information needed to support the query.

The distributed data security system may receive a response from the model that includes the hash key and (e.g., substantive) responsive data. The system may use the hash key to identify the blockchain and/or the block associated with the query and/or the communications session. The system may retrieve relevant personal information and/or communication interaction information from the blockchain block to generate a responsive communication. Other processing may also be performed as appropriate. The system may transmit this responsive communication to the user via the communications session (e.g., the session associated with the block and/or blockchain).

In some examples, the responsive communication may instead be provided to an operator of the distributed data security system for modification, supplementation, and/or approval before providing the (e.g., potentially modified) responsive communication to the user. Alternatively or additionally, the response from the model may be provided to an operator of the distributed data security system for evaluation before generating a responsive communication for the user. Included with the response from the model may be the hash key and/or data retrieved from one or more blocks and/or a blockchain associated with the hash key. The operator may then perform any modification, supplementation, and/or approval of the model response before generating and providing a responsive communication to the user.

In some examples, such an operator may determine that the generated responsive communication and/or the model response is insufficient or inaccurate. In such cases, the operation may modify or supplement the input data (e.g., the relevant non-personal information needed to support the query) to generate another model query and may provide this updated query, along with the hash key identifier, to the model for further responsive output.

The distributed data security system may process requests for historical communications session information using the disclosed distributed security techniques. For example, the system may receive a request for communications session data that may include an identifier for a user, an identifier for an interaction, and/or other information that may be used to identify a particular blockchain. The system may then extract communications session data from the identified blockchain to recreate the communications session represented by the blockchain and present the resulting communication session representation to the requesting user.

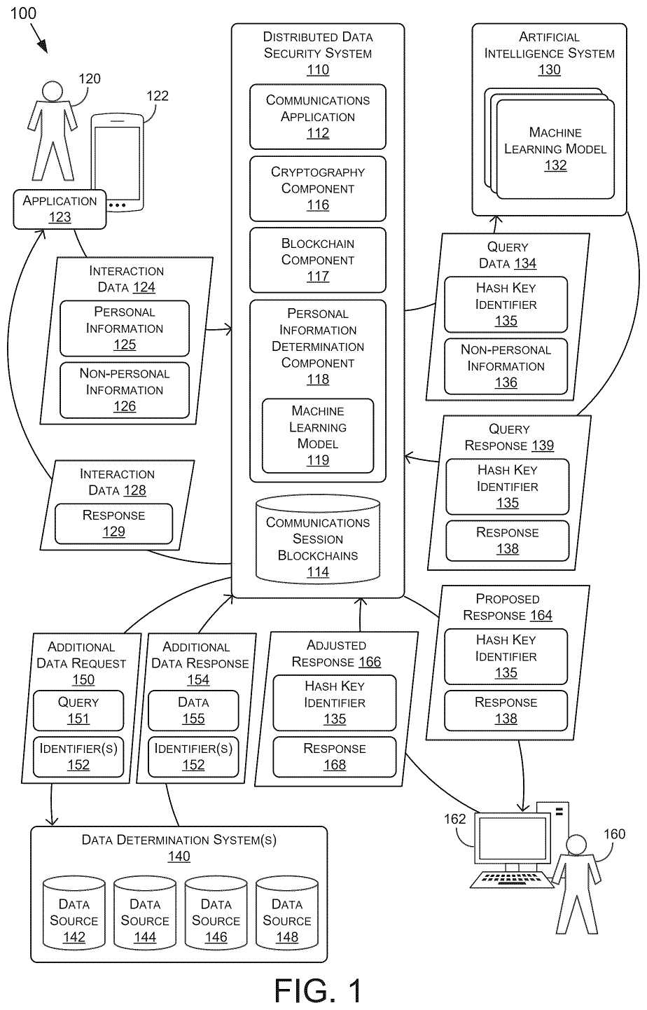

FIG. 1 illustrates an exemplary environment 100 in which various components

of a distributed data security system and associated systems such as those described herein may be configured. A distributed data security system 110 may be configured in the environment 100. The distributed data security system 110 may include or otherwise interoperate with a communications application 112 that may facilitate communications and communications sessions with user devices. In examples, the communications application 112 may be a chat application. The distributed data security system 110 may also include or otherwise access a communications session blockchains data store 114 that may be used to store one or more blockchains generated as described herein for communications sessions.

The distributed data security system 110 may also include or otherwise interoperate with a cryptography component 116 that may be configured to execute any one or more cryptographic hash functions and/or operations. For example, the cryptography component 116 may execute a cryptographic hash function using some or all of the personal information determined in or based on a communication from a user to generate a hash key as output (e.g., a cryptographic hash, a cryptographic puzzle solution). The cryptography component 116 may execute multiple such functions and determine a particular function to use based on any of a variety of criteria. Such cryptographic hash functions may be mathematical functions that generate a string as output that may serve as a hash key in the disclosed systems and techniques when executed using input data. The generated output string may be a unique, fixed-length string that is unique to the provided input when processed using a particular hash function.

The distributed data security system 110 may also include or otherwise interoperate with a blockchain component 117 that may be configured to execute any one or more blockchain functions and/or operations. For example, the blockchain component 117 may generate a blockchain and configure the blockchain with a hash key as an identifier (e.g., generated by the cryptography component 116). The blockchain component 117 may also, or instead, generate individual blocks of a blockchain and associate such blocks with a blockchain. The blockchain component 117 may also, or instead, configure such blocks with a hash key as an identifier (e.g., generated by the cryptography component 116) that may also, in some examples, be an identifier of the associated blockchain. The blockchain component 117 may also, or instead, label or otherwise identify particular blocks (e.g., as personal information blocks) and/or store data at such blocks (e.g., determined personal data, communications and/or interaction data, etc.). The blockchain component 117 may perform any other block and/or blockchain operations that may be used with the disclosed distributed data security systems and methods.

The distributed data security system 110 may also include or otherwise interoperate with a personal information determination component 118. The personal information determination component 118 may be configured to determine and/or extract personal and/or sensitive information from user communications and/or data retrieved or otherwise determined based on user communications. The personal information determination component 118 may further be configured to determine and/or extract information determined not to be personal and/or sensitive from such user communications and/or data retrieved or otherwise determined based on user communications. In some examples, the personal information determination component 118 may include a machine learning model 119 that may be trained to determine personal and/or sensitive information and/or information that is not personal and/or sensitive information from user communications and/or data retrieved or otherwise determined based on user communications. The personal information determination component 118 may be further configured to provide determined personal and/or sensitive information and/or information that is not personal and/or sensitive information to one or more other components, such as the communications application 112 and/or the cryptography component 116.

A user 120 may operate a user device 122 to participate in a communications session with the distributed data security system 110 that may, for example, be facilitated by the communications application 112. In examples, the user device 122 may be configured with an application 123 that may facilitate such a communications session. For example, the application 123 may be a web browser, app, or any other application that may provide input means to receive input from the user 120 and interaction data generation means that may generate interaction data based on this input and/or other data that may be retrieved and/or determines based on user input. For example, by interacting with the application 123, the user 120 may initiate a communications session with the distributed data security system 110.

During such a communications session, the application 123 may generate interaction data 124 that may be transmitted to the distributed data security system 110 (e.g., via one or more wired and/or wireless networks of any type, number, combination, and configuration). This interaction data may include personal information 125 and/or non-personal information 126. The personal information 125 may include data such as a username, full name, birth date, email address, telephone number, address, account number, license plate number, driver's license number, social security number, identifying information of any other type, and/or any other sensitive and/or personal information associated with the user 120. The non-personal information 126 may include any other type of data, such as query data representing a request of the user 120 (e.g., “Can I get a quote for a new car?” “Can I get a quote for homeowners on a house?) and any related information (e.g., the make, model, and/or year of a vehicle, dealer information, date of vehicle possession, etc.; zip code of house, bedrooms, floors, square footage, build date, etc.).

Note that the personal information 125 and the non-personal information 126 may be distinctly represented by the user 120 and/or in the interaction data 124, or they may be aggregated. For example, input data from the user 120 may be something like “Can I get a quote for adding a 1974 Chevy Vega to my policy 134FH79V22?” Here, the personal information (policy number) is aggregated with non-personal information (request for a quote, vehicle year, make, and model, and other possibly extraneous information).

The distributed data security system 110 may process the received interaction data 124 to determine subsequent operations. For example, the communications application 112 may process the interaction data 124 to determine the purpose of the interaction (e.g., from the non-personal information 126). The communications application 112 may provide the interaction data and/or the personal information 125 and the non-personal information 126 to the personal information determination component 118 to determine (e.g., detect and separate, in some examples using the machine learning model 119) the personal information and the non-personal information.

The distributed data security system 110 may process the determined personal information (e.g., some or all of the personal information 125) to generate a hash key to be used as a hash key identifier 135. For instance, the distributed data security system 110 may operate the cryptography component 116 to execute a cryptographic hash function using some or all (e.g., a subset) of the personal information 125 as input to generate the hash key identifier 135.

The distributed data security system 110 may further process the determined personal information and the determined hash key identifier to generate a blockchain for representing the interaction data 124. For example, the distributed data security system 110 may operate the blockchain component 117 to generate (e.g., instantiate and/or initiate) a blockchain. The blockchain component 117 may associate the hash key identifier 135 with this newly generated blockchain. Alternatively, the blockchain component 117 may retrieve a blockchain from the communications session blockchains data store 114 based on a determined hash key (e.g., that may be generated by the cryptography component 116 from a subset of the personal information 125).

The blockchain component 117 may further generate one or more blocks for this generated or determined blockchain and may store the interaction data 124 in the block(s). The blockchain component 117 may store the personal information 125 in a separate and distinct block from the non-personal information 126 and may label each such block with the hash key identifier 135. Alternatively or additionally, the blockchain component 117 may store the personal information 125 and the non-personal information 126 in a single block and may label the block with the hash key identifier 135. In either case, the block(s) may be labeled with one or more identifiers of a type of data (e.g., interaction data, personal information, non-personal information, etc.). The blockchain component 117 may store this blockchain in the communications session blockchains data store 114.

The distributed data security system 110 may initiate interaction with a (e.g., third-party) machine learning model provider to determine responsive data for providing a response to the interaction data 124. In examples, the communications application 112 may generate query data 134 that may include the hash key identifier 135 as well as non-personal information 136 that may be a subset of, or based on, the non-personal information 126. The non-personal information 136 may include, for example, a prompt for a machine learning model that is based on the interaction data 124 (e.g., that represents a request of the user 120). The distributed data security system 110 may transmit the query data 134 to an AI system 130. The AI system 130 may include a machine learning model 132, such as an LLM or other generative AI implementation. The AI system 130 may host multiple machine learning models that may be available to the distributed data security system 110. In such examples, the query data 134 may indicate the particular model to be executed to process the prompt represented by the non-personal information 136. The AI system 130 may represent any type of interaction data generation system that may be configured to generate response data and/or other interaction data that may be used to facilitate interactions with a user.

The non-personal information 136 may be a subset of the non-personal information 126 provided by the user device 122 (e.g., via the application 123) and/or information retrieved or determined by the distributed data security system 110. For example, the distributed data security system 110 may transmit an additional data request 150 to a data determination system(s) 140 requesting data from one or more of data sources 142, 144, 146, and 148 that may be accessible via the data determination system(s) 140. The additional data request 150 may include a query 151 indicating the particular data request and/or an identifier 152 that may be used by the data determination system(s) 140 to retrieve and track additional personal and/or non-personal data associated with the identifier 152. The query 151 may be based on any portion of the personal information 125 and/or the non-personal information 126. The identifier 152 may be one or more identifiers of the user 120, the device 122, the application 123, the blockchain associated with the interaction, a block associated with the requested information (e.g., at which the requested information will be stored), the hash key identifier 135, and/or any associated identifier (e.g., username, policy identifier, claim identifier, account identifier, transaction identifier, etc.).

In response to the additional data request 150, the data determination system(s) 140 may determine the requested data (e.g., from one or more of the data sources 142, 144, 146, and 148). The data determination system(s) 140 may responsively transmit an additional data response 154 to the distributed data security system 110. The additional data response 154 may include the requested data 155 as well as the identifier 152 that may allow the distributed data security system 110 to correlate the data 155 with the query 151. The distributed data security system 110 may then use this retrieved data 155 in addition to or instead of the non-personal information 126 to generate the non-personal information 136 that may be used to form the query data 134.

The AI system 130 may execute the machine learning model 132 using the non-personal information 136 as a prompt to generate a response 138 as output. In some examples, the AI system 130 may initially store the hash key identifier, execute the model 132 using the non-personal information 136, and then use the hash key identifier 135 included with query data 134 to label the response 138 output generated by the model 132. In other examples, the AI system 130 may provide the hash key identifier 135 to the machine learning model 132 along with any prompt data (e.g., the non-personal information 136), allowing the model 132 itself to identify the response 138 output as associated with the hash key identifier 135.

The AI system 130 may then generate a query response 139 that includes the response 138 representing the output of the machine learning model 132 and the hash key identifier 135. The AI system 130 may transmit the query response 139 to the distributed data security system 110.

On receipt of query response 139, the distributed data security system 110 may use the hash key identifier 135 to identify the block and/or blockchain associated with the applicable communications session. The distributed data security system 110 may retrieve this blockchain and/or block from the communications session blockchains data store 114. Using the identified block and blockchain, the distributed data security system 110 may generate a response 129 that may include responsive data represented by the response 138. The response 129 may be transmitted to the application 123 and/or the user device 122 as interaction data 128. The application 123 may then present the response 129 to the user 120 (e.g., as text and/or images in a chat application). The distributed data security system 110 may further generate additional blocks as needed for communications exchanged between the distributed data security system 110 and the user device 122.

As described herein, the response 129 provided to the user 120 may be based on the response 138. In some examples, the response 138 may be evaluated and/or modified to generate the response 129 (e.g., by the communications application 112). In various examples, the response 138 may be included in a proposed response 164 that may be transmitted, along with the key identifier 135, to an operator system 162 that may be operated by an administrative user 160. The administrative user 160 may be an agent or employee of the operator of the distributed data security system 110. The operator system 162 may present the response 138 to the user 160 for evaluation. The user 160 may determine whether and how the response is to be adjusted. For example, the user 160 may add, remove, and/or change any of the information represented in the response 138 to generate a response 168. Alternatively, the user 160 may make no changes to the response 138 to generate a response 168. The operator system 162 may transmit an adjusted response 166 to the distributed data security system 110 that includes the response 168 and the hash key identifier 135. The communications application 112 may generate the response 129 for the interaction data 128 based on the response 168.

As described herein, the distributed data security system 110 may retrieve blockchains and blockchain data from the communications session blockchains data store 114 to reconstruct communications sessions and/or determine other data based on communications sessions as described herein.

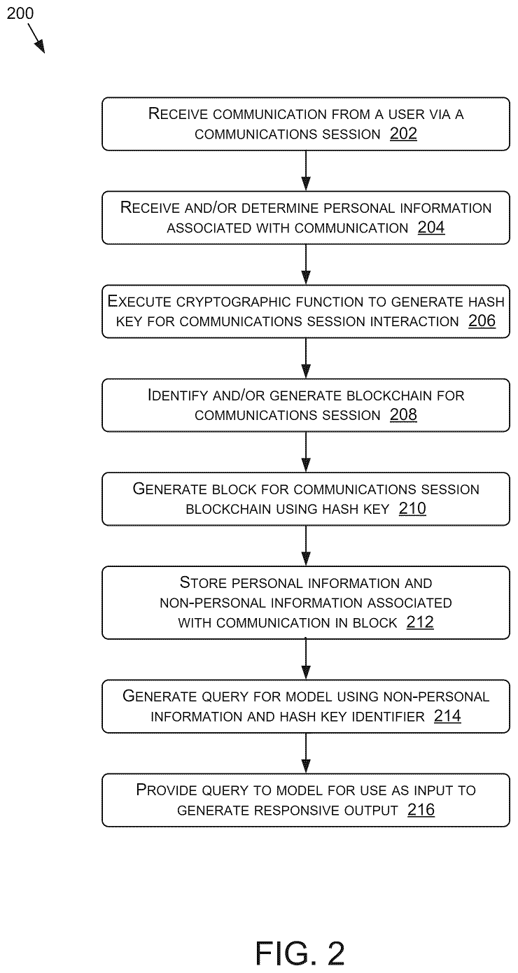

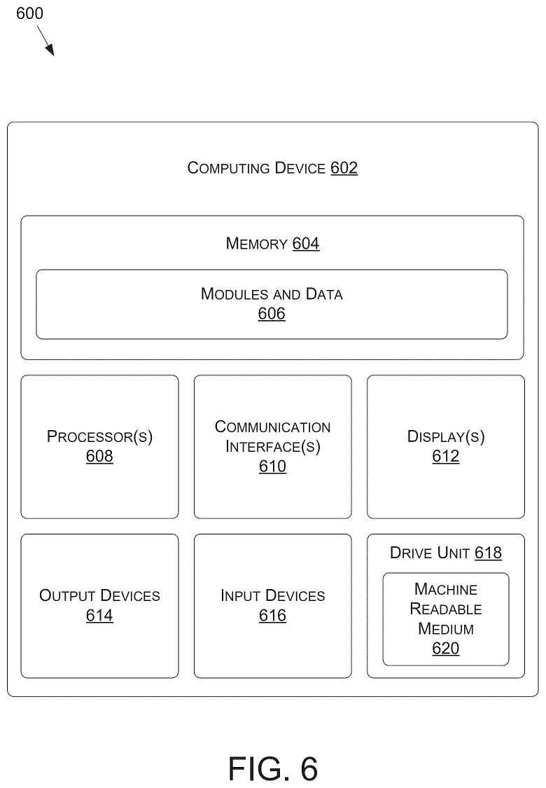

FIG. 2 is a flow diagram of an exemplary process 200 for generating a query to a machine learning model that may be implemented at a distributed data security system. In examples, one or more operations of the process 200 may be implemented by a distributed data security system, such as by using one or more of the components and systems illustrated in FIG. 1 and described above and/or by using one or more of the components and systems illustrated in FIG. 6 and described below. For example, one or more such components and systems can include those associated with the communications application 112, the cryptography component 116, the blockchain component 117, and/or the personal information determination component 118 illustrated in FIG. 1. One or more such components and systems can also, or instead, include those associated with the computing device 600 illustrated in FIG. 6. In other examples, one or more operations of the process 200 may be performed by a combination of components described in regard to these systems and/or other systems. However, the process 200 is not limited to being performed by such components and systems, and the components and systems described herein are not limited to performing the operations of the process 200.

At operation 202, a distributed data security system (which, as used herein, includes any one or more systems and/or components interacting with a distributed data security system, such as a chat application or other type of communications application; e.g., the distributed data security system 110 and/or any one or more components configured therein) may receive a communication from a user, for example, within a communications session. For example, a user and/or the system (e.g., user 120 and/or application 123 executing on user device 122) may initiate a chat session and transmit a chat communication (e.g., interaction data 124) via the chat session to the distributed data security system. In examples, this communication may be a customer query and/or request, such as a request for insurance policy and/or claim status or other related data, a request for information associated with an insurance policy and/or claim, etc. Other types of requests are contemplated, such as requests for account information for any type of account, sale information for any type of sale or purchase, transaction information for any type of transaction, etc. This communication may include personal information (e.g., personal information 125) and/or non-personal information (e.g., non-personal information 126).

At operation 204, the distributed data system may determine or receive personal information associated with the communication received at 202. For example, the system (e.g., the personal information determination component 118) may identify personal information contained within the communication. Alternatively or additionally, the system may, in response to the communication, retrieve or otherwise obtain personal information, such as from a data store or other source based on (e.g., personal and/or non-personal information) in the communications (e.g., username, account number, policy number, etc.). For instance, the system may determine personal information using external, local, and/or third-party data sources (e.g., via data determination system(s) 140 and/or data sources 142, 144, 146, 148). In examples, the system may identify distinct personal information and non-personal information associated with the communication at operation 204.

In some examples, at operation 204, the system may execute a machine learning model (e.g., machine learning model 119) using some or all of the data included in the communication received at operation 202 as input to generate output indicating distinct personal and/or non-personal data represented in the communication. This model may be trained to evaluate text and/or other types of data to distinguish between personal and non-personal information and to generate, as output, indications of such information (e.g., identifying the specific personal and/or non-personal information included in the input data).

At operation 206, the system (e.g., the cryptography component 116) may execute a cryptographic function to generate, as output, a hash key using at least a subset of the personal information determined at 204 as input. For example, the system may use the personal information as input to a cryptographic hash function and/or other algorithm to generate a hash key identifier, as described herein.

At operation 208, the system (e.g., the blockchain component 117) may determine a blockchain associated with the communications session. In examples, a blockchain may be instantiated or otherwise generated for each communications session initiated. If the communication received at operation 202 is a first or initial communication in a particular communications session, the blockchain for the session may be created at operation 208. The generated hash key identifier of the operation 206 may be used as an identifier of this generated blockchain. Alternatively or additionally, other personal and/or non-personal information may instead, or also, be used as a blockchain identifier (e.g., username, account number, chat session identifier, policy identifier, user device IP address, etc.).

If this is not a first or initial communication in a particular communications session, the system may identify an existing blockchain for the communications session, for example, based on an identifier associated with the communication received at operation 202 (e.g., username, account number, chat session identifier, policy identifier, user device IP address, etc.). In examples, the system may determine whether this is a first or initial communication in a particular communications session by determining an identifier based on the communication and then determining whether an existing blockchain is associated with the identifier (e.g., in the communications session blockchains data store 114).

For example, particular personal information received at operation 202 may be used to determine a hash key identifier (as described for the operation 206) that may then be used to identify an existing blockchain for the communications session. For instance, a username or account number may be contained in each communication received from a user device (e.g., an application executing on the user device). This username or account number may be used as input to a cryptographic function to generate a hash key identifier that may then be used to query a data store of existing blockchains (e.g., communications session blockchains data store 114) for a matching blockchain identifier. The system may then retrieve the blockchain with the matching hash key identifier for processing as described herein. If there is no matching hash key identifier in the data store of existing blockchains, the system may generate a new blockchain at operation 208 and may identify this new blockchain using the generated hash key identifier. In examples, the system may query the data store of existing blockchains using the has key identifier and, if the data store of existing blockchains returns a null result indicating no existing blockchain associated with the hash key identifier, the system may generate a new blockchain using the hash key identifier. Otherwise, the system may use the blockchain identified by the data store of existing blockchains in response to the query.

At operation 210, the system may generate a block for the communications session blockchain representing the communication received at operation 202. This block may be identified using the hash key generated at 208. This may be in place of, or in addition to, a block hash generated using the block header metadata. In examples, the personal information-based hash key identifier may be stored as data within the block.

At operation 212, the system may then store the personal information and the non-personal information associated with the communication in the block and integrate the block into the communications session blockchain. The personal information and/or non-personal information of the communication may be stored in the block in any form (e.g., encrypted using a two-way encrypt function and/or algorithm to allow decryption and retrieval; note this is inherent in most blockchain implementations and therefore data stored in a block is typically considered secure). Other communication-related data may be generated and stored in this block, such as time of receipt, the IP address of a source device, an identifier of a source application, determined user information (e.g., username, account number, telephone number, etc.) that may not have been included in the communication but instead may have been determined using information in the communication, etc.

At operation 214, the system (e.g., the communications application 112) may then generate a query for a model (e.g., an LLM, other generative AI, etc.) based on the communication using a subset of the non-personal information determined at operation 204 and/or other non-personal data determined by the system (e.g., query data 134). The query may include one or more prompts for use as input to a machine learning model (e.g., the non-personal information 136). This query may also include the hash key generated at the operation 206 (e.g., the hash key identifier 135) and/or an identifier associated with the communications session. At operation 216, the generated query may then be provided to a model (e.g., the machine learning model 132 and/or the AI system 130) at operation 216.

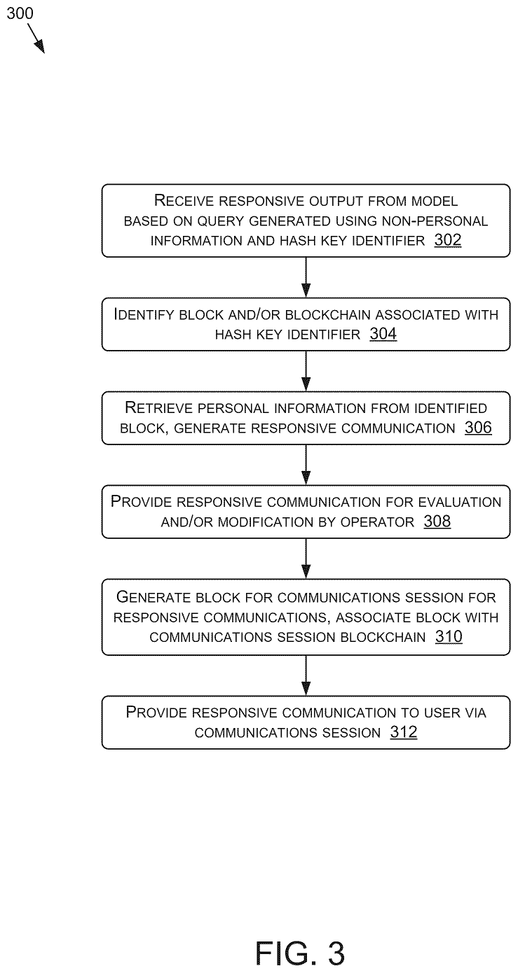

FIG. 3 is a flow diagram of an exemplary process 300 for generating a responsive query for transmission to an application executing on a user device that may be implemented at a distributed data security system. In examples, one or more operations of the process 300 may be implemented by a distributed data security system, such as by using one or more of the components and systems illustrated in FIG. 1 and described above and/or by using one or more of the components and systems illustrated in FIG. 6 and described below. For example, one or more such components and systems can include those associated with the communications application 112, the cryptography component 116, the blockchain component 117, and/or the personal information determination component 118 illustrated in FIG. 1. One or more such components and systems can also, or instead, include those associated with the computing device 600 illustrated in FIG. 6. In other examples, one or more operations of the process 300 may be performed by a combination of components described in regard to these systems and/or other systems. However, the process 300 is not limited to being performed by such components and systems, and the components and systems described herein are not limited to performing the operations of the process 300.

At operation 302, the system (e.g., the communications application 112) may receive responsive output from a model (e.g., the query response 139). For example, in response to receiving the query generated and provided to the model using the process 200 of FIG. 2 (e.g., the query data 134), the model (e.g., the machine learning model 132 and/or the AI system 130) may generate responsive output and transmit that output to the distributed data security system.

At operation 304, the system (e.g., the communications application 112 and/or the blockchain component 117) may identify the blockchain and/or communications session associated with the output received from the model. In particular examples, the system may also identify the particular block within the blockchain that is associated with (e.g., the basis for) the query provided to the model that resulted in the output provided by the model. For example, the model output may include the hash key (e.g., the hash key identifier 135 included in the query response 139), a communications session identifier, and/or another identifier that may be associated with the communications session and/or the communications session blockchain. Using the model output, the system may identify a particular block in a particular communications session blockchain associated with input used to generate the model output. For example, the system may query a communications data store using the hash key identifier (e.g., query communications session blockchains data store 114 for a matching blockchain identifier). The system may further retrieve any or all of the identified block and/or blockchain for processing as described herein.

At operation 306, the system may determine or retrieve, from the identified block, personal information that may be needed to form an appropriate responsive communication. For example, the system may retrieve personal information (e.g., decrypt an encrypted representation of the personal information; note this may be inherent in accessing the block as a decryption key may be required to decrypt data within a block in typical blockchain implementations) from the block and select the information needed to generate a responsive communication.

In some examples, no personal information may be needed to generate a response. For example, the response may be an estimate or a quote that is primarily a numerical value with some descriptive information (e.g., “Your quote is $650 for six months of full coverage”). In such cases, retrieval of personal data may not be required for generating the response. Either way, further at operation 306, this responsive communication may be generated (e.g., interaction data 128 including the response 129 and/or proposed response 164 including the response 138).

At operation 308, in some examples, the responsive communication (e.g., the proposed response 164, including the response 138) may be provided for evaluation and/or modification by an operator and/or other system or component (e.g., the operator system 162 and/or the administrative user 160). For example, the response may be provided to an operator for evaluation of accuracy, appropriateness, completeness, etc. In examples, the operator or other evaluator may modify and/or supplement the response and/or may request additional information from the model and/or any other system to improve the content of the responsive communication. This updated or adjusted response (e.g., the adjusted response 166 including the response 168) may be provided to the system for use in generating and sending a response to the user. An identifier may accompany the communications exchanged between the operator system and the distributed data security system, such as the hash key identifier associated with the communications session and/or the blockchain (e.g., the hash key identifier 135).

At operation 310, the system may generate a block for the communications session blockchain that may be used to represent or may otherwise be associated with the responsive communication generated at operation 306 and/or operation 308. The system may further integrate the block into the blockchain at operation 310. As described herein, each individual communication of the communications session (e.g., a communication received from the user via an application or a communication transmitted to an application and intended for the user) may be tracked using, and/or otherwise associated with, an individual block in the communications session blockchain. At operation 312, the responsive communication (e.g., the interaction data 128 including the response 129) may be provided to the user (e.g., the participant in the communication session, such as the user 120) via an application (e.g., the application 123) executing on a user device (e.g., the user device 122).

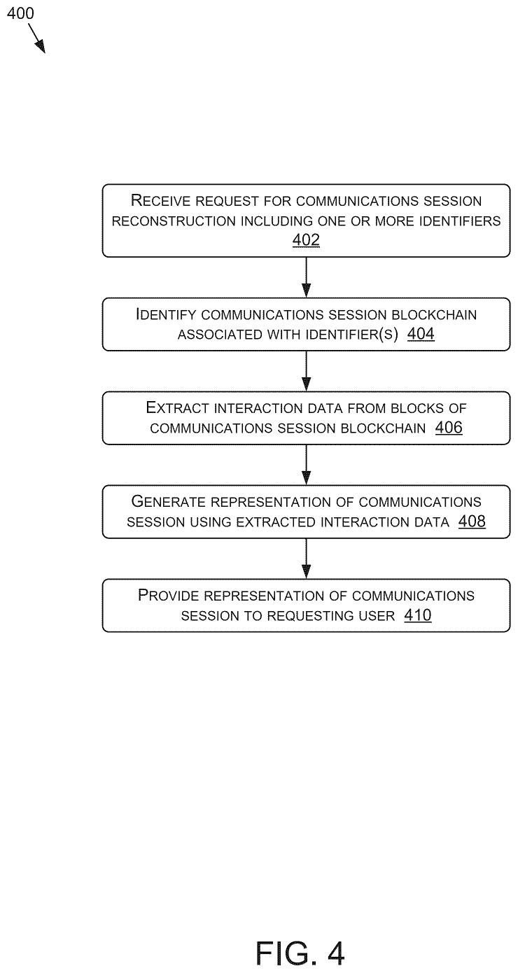

FIG. 4 is a flow diagram of an exemplary process 400 for generating a representation of a communications session based on a blockchain associated with the communications that may be implemented at a distributed data security system. In examples, one or more operations of the process 400 may be implemented by a distributed data security system, such as by using one or more of the components and systems illustrated in FIG. 1 and described above and/or by using one or more of the components and systems illustrated in FIG. 6 and described below. For example, one or more such components and systems can include those associated with the communications application 112, the communications session blockchains data store 114, the cryptography component 116, the blockchain component 117, and/or the personal information determination component 118 illustrated in FIG. 1. One or more such components and systems can also, or instead, include those associated with the computing device 600 illustrated in FIG. 6. In other examples, one or more operations of the process 400 may be performed by a combination of components described in regard to these systems and/or other systems. However, the process 400 is not limited to being performed by such components and systems, and the components and systems described herein are not limited to performing the operations of the process 400.

At operation 402, the system (e.g., the distributed data security system 110 and/or any component configured therein) may receive a request for a reconstruction of a communications session and/or other data associated with a particular (e.g., completed or ongoing) communications session. This request may include one or more identifiers that may be used to identify a communications session and/or a communication session blockchain. In some examples, the request may include a hash key identifier as described herein. In other examples, the request may include data that may be used to determine a hash key identifier. For instance, personal information on which hash keys may be generated may be included in this request (e.g., username, account number, full name, telephone number, etc.). The system (e.g., the cryptography component 116) may then generate a hash key identifier at operation 402 in response to the received request.

At operation 404, using this determined and/or received identifier, the system may identify the blockchain associated with the communications session for which a reconstruction or other data was requested at operation 402. For example, the system may identify a blockchain from a data store of existing blockchains (e.g., communications session blockchains data store 114) by determining a matching blockchain identifier. In some examples, the request received at the operation 402 may also include a date or time, allowing the system to identify a distinct communications session and/or blockchain from among multiple sessions and/or blockchains that may be associated with a particular piece of personal information (e.g., representing multiple communications sessions with the same user).

At operation 406, the system may extract interaction and/or communication data from the individual blocks of the identified blockchain. For example, the text content of communications exchanged during the communications session may be stored in the individual blocks, where each block stores text content for an individual communication (e.g., from one participant to another at a particular time). The blocks may also store other data that may be used to reconstruct a communications session, such as personal information, non-personal information, timestamps (a time of receipt, detection, and/or transmission of a communication), formatting, images, audio, video, etc. that may be associated with a communication. The system may use such data to generate a reconstruction of the communications session.

At operation 408, using this data, the system may generate a representation of the communications session. Such a representation may take any suitable form, such as a text document, a webpage, a graphical representation, etc. In various examples, the generated representation may be one or more computer-executable instructions that, when stored in a non-transitory computer-readable medium and executed by a one or more processors configured at a computing device, cause the computing device to generate a visual representation of the communications session, for instance, in a graphical user interface displayed on a computing device display. Further at operation 410, this representation may be provided to the user, system, component, or device that requested the reconstruction (e.g., the operator system 162, the user device 122, the application 123).

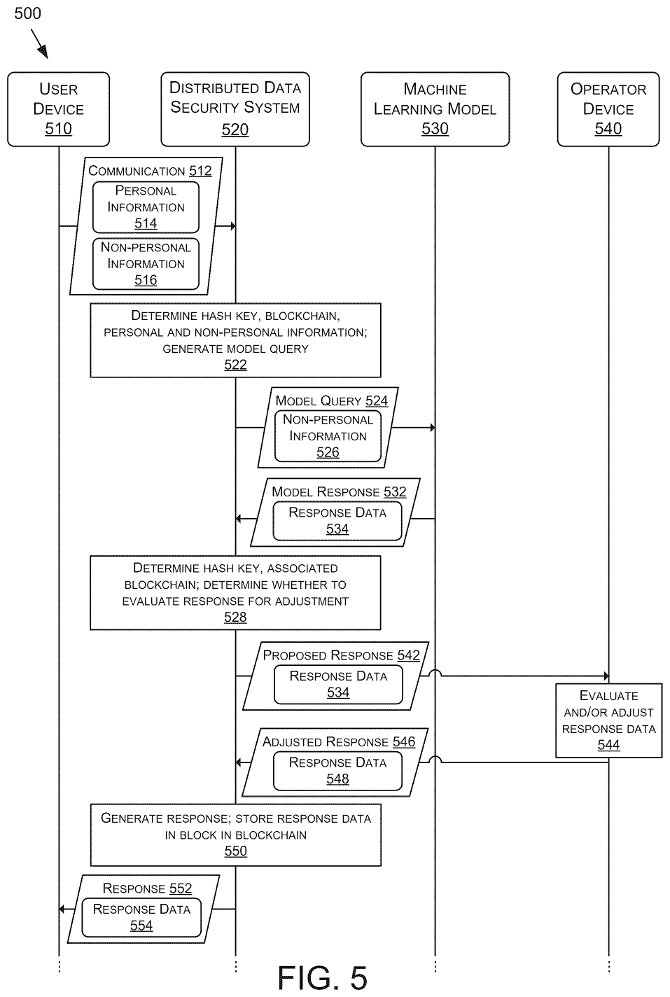

FIG. 5 illustrates an exemplary signal flow 500 that may be performed using various components of a distributed data security system such as those described herein. In examples, the various operations and communications illustrated in FIG. 5 may be performed and/or exchanged by various components and systems, such as those illustrated in FIG. 1 and described above and/or those illustrated in FIG. 6 and described below. However, the various operations and communications illustrated in FIG. 5 are not limited to being performed by such components and systems, and the components and systems described herein are not limited to performing the operations and communications illustrated in FIG. 5.

In the signal flow 500, a distributed data security agent or application (e.g., communication application 112) that may be a component of a distributed data security system may facilitate interactions with a user, such as a customer, and ensure the security of the user's personal information. The signals exchanged during a communications session may begin when the agent initializes (“start”) a communications session with a user. In this example, the agent may operate a chat application to exchange communications with a user. The agent may also retrieve and/or determine data that may be associated with the chat session and/or individual communications within the chat session. This may include determining and/or retrieving personal information and/or non-personal information based on the individual communications. For example, the agent may determine personal and non-personal information from communications and/or access one or more data sources to obtain such information.

The agent may generate and/or identify a blockchain for the communications session and generate a hash key for the personal information that may be included in an individual communication. Using the non-personal information and/or anonymized representations of personal information, the agent may generate a query and/or other input for an LLM that may be used to execute the LLM and generate responsive output. This responsive model output may be used by the agent to identify the communications session blockchain block used to generate the model input and generate a response that may be provided back to the user via the chat application. The agent may further generate blocks for the blockchain associated with such responsive communications.

A generated response may be evaluated by an operator (“Ops Representative”). The operator may determine whether the response is valid (e.g., accurate, clear, sufficient, etc.). The operator may adjust the response by modifying and/or supplementing the response content and/or performing any other actions, including initiating further interactions with the LLM. The updated response may be provided to the agent and then back to the user via the chat application.

In the signal flow 500, a user device 510 may transmit a communication 512 to a distributed data security system 520. The communication 512 may include personal information 514 and/or non-personal information 516, in examples, such as described herein.

In response to the communication 512, the distributed data security system 520 may, at an operation 522, determine a hash key (e.g., based on the personal information 514). Further at the operation 522, the distributed data security system 520 may determine a blockchain associated with the hash key or, if no such blockchain can be determined (e.g., the communication 512 is an initial or first communication in a communication session), the distributed data security system 520 may generate a blockchain and identify or otherwise associate the blockchain with the hash key. For instance, the distributed data security system 520 may use the hash key as the public key used to create the blockchain. Further at the operation 522, the distributed data security system 520 may determine and/or otherwise distinguish the personal information 514 and/or the non-personal information 516 (in some cases prior to generating the hash key as some or all of the personal information 514 and/or the non-personal information 516 may be used in generating the hash key). Further at the operation 522, the distributed data security system 520 may generate a model query. This query may include one or more model prompts and/or other data that may be provided to a model and/or AI system for execution and generation of response data.

The distributed data security system 520 may transmit a model query 524 to a machine learning model 530. The model query 524 may include non-personal information 526 that includes one or more model prompts and/or any other data that may be used by the model to generate response data. This non-personal information 526 may also include one or more identifiers, such as a hash key, that may be used by the distributed data security system 520 to identify the associated blockchain and/or communications session upon receipt of response data from the machine learning model 530.

The machine learning model 530 may reply with model response 532 that may include response data 534. This response data 534 may include data generated by the machine learning model 530 based on the input data and other prompts provided in the model query 524. The response data 534 may also include one or more identifiers, such as a hash key, that may be used by the distributed data security system 520 to identify an associated blockchain and/or communications session.

In response to the model response 532, the distributed data security system 520 may, at an operation 528, determine a hash key or other identifier from the response data 534 and use this identifier to determine an associated blockchain and/or block associated with a communications session. In examples, the distributed data security system 520 may store the response data 534 and/or other data associated with the model response 532 in a block (e.g., an existing block or a new block) of this blockchain.

Further at the operation 528, the distributed data security system 520 may determine whether the response data 534 is to be evaluated and/or adjusted. For example, the content of the response data 534 may represent a simple confirmation or other information that may be unlikely to be misunderstood and/or incorrect. In some cases, the distributed data security system 520 may determine that the response can simply be sent. In such cases, the distributed data security system 520 may then, at an operation 550, generate a response and store the response and related data in a block (a new or existing block) in the associated blockchain (e.g., using the hash key as a blockchain identifier). The distributed data security system 520 may transmit the response as response 552, including response data 554 that may be substantially the same as the response data 534.

Alternatively, the distributed data security system 520 may determine that the response data 534 is to be evaluated and/or adjusted. For example, the content of the response data 534 may represent a numerical calculation or a qualitative and/or quantitative data that may be misunderstood and/or incorrect. In such cases, the distributed data security system 520 may transmit the response data 534 in a proposed response 542 to an operator device 540 for evaluation and possible adjustment.

An operator or an automated system or application may evaluate the response data 534 at an operation 544. For example, the operator device 540 may verify the accuracy of the information in the response data 534, determine whether the language is appropriate, determine if there is too much or too little detail included, etc. If the operator device 540 determines that adjustments are needed, further at the operation 544, the operator device 540 may perform such adjustments to generate adjusted response data 548. Alternatively, the response data 548 may be the same or substantially identical to the response data 534 if the operator device 540 determines that no adjustments are needed to the response data 534. The operator device 540 may transmit the response data 548 to the distributed data security system 520 in an adjusted response 546.

In response to receiving the adjusted response 546, the distributed data security system 520 may, at the operation 550, generate a response and store the response and related data in a block (a new or existing block) in the associated blockchain (e.g., using the hash key as a blockchain identifier). The distributed data security system 520 may transmit the response as response 552, including response data 554 that may be substantially the same as the response data 548.

FIG. 6 shows an example system architecture 600 for a computing device 602 associated with the distributed data security system described herein. The computing device 602 can be a server, computer, or other type of computing device that executes one or more portions of a distributed data security system, such as communications sessions functions, blockchain functions, machine learning and/or generative AI model execution functions, and/or any other components or portions of distributed data security system. In some examples, elements of the distributed data security system can be distributed among, and/or be executed by, multiple computing devices similar to the computing device shown in FIG. 6. For example, a communications session function may execute on a different computing device than a distributed data security system.

The computing device 602 can include memory 604. In various examples, the memory 604 can include system memory, which may be volatile (such as RAM), non-volatile (such as ROM, flash memory, etc.) or some combination of the two. The memory 604 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 602 associated with the distributed data security system. Any such non-transitory computer-readable media may be part of the computing device 602.

The memory 604 can store modules and data 606. The modules and data 606 can include one or more of the distributed data security system functions, communications session functions, blockchain functions, and/or other elements described herein. Additionally, or alternately, the modules and data 606 can include any other modules and/or data that can be utilized by the distributed data security system to perform or enable performing any action taken by the distributed data security system. Such other modules and data can include a platform, operating system, and applications, and data utilized by the platform, operating system, and applications.

The computing device 602 associated with the distributed data security system can also have processor(s) 608, communication interfaces 610, display 612, output devices 614, input devices 616, and/or a drive unit 618 including a machine-readable medium 620.

In various examples, the processor(s) 608 can be a central processing unit (CPU), a graphics processing unit (GPU), both a CPU and a GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing computer applications stored in the memory 604, which can be associated with common types of volatile (RAM) and/or nonvolatile (ROM) memory.

The communication interfaces 610 can include transceivers, modems, interfaces, antennas, telephone connections, and/or other components that can transmit and/or receive data over networks, telephone lines, or other connections.

The display 612 can be a liquid crystal display, or any other type of display commonly used in computing devices. For example, a display 612 may be a touch-sensitive display screen and can then also act as an input device or keypad, such as for providing a soft-key keyboard, navigation buttons, or any other type of input.

The output devices 614 can include any sort of output devices known in the art, such as a display 612, speakers, a vibrating mechanism, and/or a tactile feedback mechanism. Output devices 614 can also include ports for one or more peripheral devices, such as headphones, peripheral speakers, and/or a peripheral display.

The input devices 616 can include any sort of input devices known in the art. For example, input devices 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable medium 620 can store one or more sets of instructions, such as software or firmware, that embody any one or more of the methodologies or functions described herein. The instructions can also reside, completely or at least partially, within the memory 604, processor(s) 608, and/or communication interface(s) 610 during execution thereof by the computing device 602 associated with the improvement tool recommendation system. The memory 604 and the processor(s) 608 also can constitute machine-readable media 620.

Overall, one or more rules-based, machine-learning, and/or machine-learned models can be trained to perform distributed data security system operations and generate distributed data security determinations that may more accurately reflect effective distributed data security operations. For example, as described herein, a distributed data security system may be executed using data associated with a user and/or context as input to generate machine learning model input data as output. This output may be more likely to reflect effective model queries based on a user or customer query, thereby facilitating improved secure query generation and reducing the utilization of processing, memory, and network resources that would have been wasted using less effective or ineffective distributed data security tools.

Accordingly, by more accurately and efficiently determining distributed data security operations and associated data, delays and inefficiencies associated with manually or using less efficient means for performing distributed data security operations may be avoided. For example, network bandwidth usage, processing cycles, memory usage, and/or other computing resources associated with the use of ineffective distributed data security operations may be reduced or eliminated by using the distributed data security systems and techniques described herein.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method for securely generating interaction data for a communications session, the computer-implemented method comprising:
receiving, at a distributed data security system, from a user device, user interaction data comprising personal data and non-personal data;
executing, at the distributed data security system, a cryptographic function using a subset of the personal data to generate a hash key identifier;
querying, by the distributed data security system, using the hash key identifier, an encrypted data structure data store;
receiving, at the distributed data security system, from the encrypted data structure data store, query results data;
storing, at the distributed data security system, based at least in part on the query results data, a subset of the user interaction data at a first data unit of an encrypted data structure associated with the hash key identifier;
transmitting, from the distributed data security system, to an interaction data generation system, the hash key identifier and a subset of the non-personal data and excluding the personal data;
receiving, at the distributed data security system, from the interaction data generation system, responsive interaction data;
generating, at the distributed data security system, response data based at least in part on the responsive interaction data and the personal data;
storing, at the distributed data security system, a subset of the response data at a second data unit of the encrypted data structure; and
transmitting, from the distributed data security system, to the user device, the response data.

2. The computer-implemented method of claim 1, further comprising:
determining, at the distributed data security system, based at least in part on the responsive interaction data, the hash key identifier; and
retrieving, at the distributed data security system, from the encrypted data structure data store, using the hash key identifier, the encrypted data structure.

3. The computer-implemented method of claim 2, further comprising:
generating, at the distributed data security system, based at least in part on receiving the responsive interaction data, the second data unit; and
associating, at the distributed data security system, the second data unit with the encrypted data structure.

4. The computer-implemented method of claim 1, wherein:
the query results data comprises an indicator of the encrypted data structure, and
the computer-implemented method further comprises:
generating, at the distributed data security system, based at least in part on receiving the user interaction data, the first data unit; and
associating, at the distributed data security system, the first data unit with the encrypted data structure.

5. The computer-implemented method of claim 1, wherein:
the query results data comprises a null result, and
the computer-implemented method further comprises:
generating, at the distributed data security system, based at least in part on the null result and the hash key identifier, the encrypted data structure;
generating, at the distributed data security system, based at least in part on receiving the user interaction data, the first data unit; and
associating, at the distributed data security system, the first data unit with the encrypted data structure.

6. The computer-implemented method of claim 1, further comprising:
receiving, at the distributed data security system, from an operator device, a request for a communications session reconstruction;
determining, at the distributed data security system, based at least in part on the request, the hash key identifier;
retrieving, by the distributed data security system, using the hash key identifier, the encrypted data structure;
generating, by the distributed data security system, using the encrypted data structure, communications session reconstruction data; and
transmitting, from the distributed data security system, to the operator device, communications session reconstruction data causing the operator device to generate a visual representation of the communications session.

7. The computer-implemented method of claim 1, further comprising:
determining, by the distributed data security system, from an external data source, using the personal data, additional non-personal data; and
transmitting, from the distributed data security system, to the interaction data generation system, with the hash key identifier and the subset of the non-personal data, the additional non-personal data.

8. A non-transitory computer-readable medium comprising instructions that, when executed by one or more processors configured at a distributed data security system, cause the one or more processors to securely generate interaction data for a communications session by performing operations comprising:
receiving, from a user device, user interaction data comprising personal data and non-personal data;
executing a cryptographic function using a subset of the personal data to generate a hash key identifier;
storing a subset of the user interaction data at a first block of a blockchain associated with the hash key identifier;
transmitting, to an interaction data generation system, the hash key identifier and a subset of the non-personal data;
receiving, from the interaction data generation system, responsive interaction data;
generating response data based at least in part on the responsive interaction data and the personal data;
storing a subset of the response data at a second block of the blockchain; and
transmitting, to the user device, the response data.

9. The non-transitory computer-readable medium of claim 8, wherein generating the response data comprises:
transmitting the responsive interaction data and the hash key identifier to an operator device;
receiving adjusted responsive interaction data and the hash key identifier from the operator device; and
generating response data based at least in part on the adjusted responsive interaction data and the personal data.

10. The non-transitory computer-readable medium of claim 9, further comprising, in response to receiving the adjusted responsive interaction data:
determining the blockchain based at least in part on the hash key identifier;
generating a third block of the blockchain; and
storing the adjusted responsive interaction data at the third block.

11. The non-transitory computer-readable medium of claim 8, wherein the operations further comprise:
determining, from an external data source, using the personal data, additional non-personal data; and
transmitting, to the interaction data generation system, with the hash key identifier and the subset of the non-personal data, the additional non-personal data.

12. The non-transitory computer-readable medium of claim 8, wherein the operations further comprise:
generating, based at least in part on the hash key identifier, the blockchain;
generating, based at least in part on receiving the user interaction data, the first block; and
associating the first block with the blockchain.

13. The non-transitory computer-readable medium of claim 12, wherein the operations further comprise:
generating, based at least in part on receiving the responsive interaction data, the second block; and
associating the second block with the blockchain.

14. The non-transitory computer-readable medium of claim 8, wherein the responsive interaction data comprises one or more of text, images, or video.

15. A distributed data security system for securely generating interaction data for a communications session, the distributed data security system comprising:
one or more processors; and
a non-transitory memory storing computer-executable instructions that, when executed, cause the one or more processors to perform operations comprising:
receiving, from a user device, user interaction data comprising personal data and non-personal data;
executing a cryptographic function using a subset of the personal data to generate a hash key identifier;
storing a subset of the user interaction data at a first block of a blockchain associated with the hash key identifier;
transmitting, to an interaction data generation system, the hash key identifier and a subset of the non-personal data;
receiving, from the interaction data generation system, responsive interaction data;
generating response data based at least in part on the responsive interaction data and the personal data;
storing a subset of the response data at a second block of the blockchain; and
transmitting, to the user device, the response data.

16. The distributed data security system of claim 15, wherein the operations further comprise:
determining, based at least in part on the responsive interaction data, the hash key identifier; and
retrieving, from a blockchain data store, using the hash key identifier, the blockchain.

17. The distributed data security system of claim 16, wherein the operations further comprise:
generating, based at least in part on receiving the responsive interaction data, the second block; and
associating the second block with the blockchain.

18. The distributed data security system of claim 15, wherein the operations further comprise transmitting, to the interaction data generation system, with the hash key identifier and the subset of the non-personal data, one or more machine learning model prompts.

19. The distributed data security system of claim 15, wherein the operations further comprise:
receiving, from an operator device, a request for a communications session reconstruction;
determining, based at least in part on the request, the hash key identifier;
retrieving, using the hash key identifier, the blockchain;
generating, using the blockchain, communications session reconstruction data; and
transmitting, to the operator device, communications session reconstruction data, causing the operator device to generate a visual representation of a communications session represented by the blockchain.

20. A system for securely generating interaction data for a communications session, the system comprising:
means for receiving, from a user device, user interaction data comprising personal data and non-personal data;
means for executing a cryptographic function using a subset of the personal data to generate a hash key identifier;
means for storing a subset of the user interaction data at a first block of a blockchain associated with the hash key identifier;
means for transmitting, to an interaction data generation system, the hash key identifier and a subset of the non-personal data;
means for receiving, from the interaction data generation system, responsive interaction data;
means for generating response data based at least in part on the responsive interaction data and the personal data;
means for storing a subset of the response data at a second block of the blockchain; and
means for transmitting, to the user device, the response data.
